(19) United States
(12) Patent Application Publication
(10) Pub. No.: US 2024/0168410 A1
(43) Pub. Date: May 23, 2024

(54) IMAGE FORMING APPARATUS

(71) Applicant: FUJIFILM Business Innovation Corp., Tokyo (JP)

(72) Inventors: Arichika TANAKA, Kanagawa (JP); Naoya NANRI, Kanagawa (JP); Yutaka KIUCHI, Kanagawa (JP); Go MIURA, Kanagawa (JP); Kenta TONOSU, Kanagawa (JP)

(73) Assignee: FUJIFILM Business Innovation Corp., Tokyo (JP)

(21) Appl. No.: 18/295,939

(22) Filed: Apr. 5, 2023

(30) Foreign Application Priority Data
Nov. 18, 2022 (JP) 2022-185003

(51) Int. Cl. G03G 15/16

(52) U.S. Cl. CPC G03G 15/1605

(57) ABSTRACT

An image forming apparatus includes: a plural image forming units configured to form respective toner images in different colors; an endless-shaped intermediate transfer member that is rotatable in a peripheral direction of the intermediate transfer member and to which the toner images are to be sequentially transferred from the plural image forming units; a moment-of-inertia-increasing structure provided to one of rotatable image carriers that are included in the respective image forming units, the moment-of-inertia-increasing structure increasing a moment of inertia of the one image carrier relative to moments of inertia of other ones of the image carriers, the one image carrier being included in one of the image forming units that is located at a downstreammost position in a direction of rotation of the intermediate transfer member, the image carriers being in contact with the intermediate transfer member and configured to carry the respective toner images; a plural first-transfer units provided at positions across from the respective image carriers and configured to transfer the toner images carried by the image carriers to the intermediate transfer member; and a second-transfer unit provided on a downstream side relative to the plural first-transfer units in the direction of rotation of the intermediate transfer member and configured to transfer the toner images on the intermediate transfer member to a medium.

### CROSS-REFERENCE TO RELATED APPLICATIONS

This application is based on and claims priority under 35 USC 119 from Japanese Patent Application No. 2022-185003 filed Nov. 18, 2022.

### BACKGROUND

### (i) Technical Field

The present disclosure relates to an image forming apparatus.

### (ii) Related Art

An image forming apparatus disclosed by Japanese Unexamined Patent Application Publication No. 2011-169950 includes an image carrier on an endless peripheral surface of which a latent image produced as an electrostatic potential difference is to be formed, a developing device configured to form a toner image by causing toner to adhere to the image carrier, an endless-shaped intermediate transfer belt stretched over a plurality of roll members and which receives the toner image in a first-transfer process by being in contact with the image carrier, a second-transfer device configured to transfer the toner image received by the intermediate transfer belt in the first-transfer process to a recording sheet, and an elastic member to be pressed against the inner peripheral surface of the intermediate transfer belt at a position in the direction of rotation of the intermediate transfer belt that is between a first-transfer position where the first-transfer process for the toner image is to be performed and a second-transfer position where the intermediate transfer belt faces the second-transfer device.

### SUMMARY

Aspects of non-limiting embodiments of the present disclosure relate to an image forming apparatus that is less likely to cause nonuniformity in image density than in a case where a plurality of image carriers included in respective image forming units exhibit moments of inertia that are substantially equal to one another.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a plurality of image forming units configured to form respective toner images in different colors; an endless-shaped intermediate transfer member that is rotatable in a peripheral direction of the intermediate transfer member and to which the toner images are to be sequentially transferred from the plurality of image forming units; a moment-of-inertia-increasing structure provided to one of rotatable image carriers that are included in the respective image forming units, the moment-of-inertia-increasing structure increasing a moment of inertia of the one image carrier relative to moments of inertia of other ones of the image carriers, the one image carrier being included in one of the image forming units that is located at a downstreammost position in a direction of rotation of the intermediate transfer member, the image carriers being in contact with the intermediate transfer member and configured to carry the respective toner images; a plurality of first-transfer units provided at positions across from the respective image carriers and configured to transfer the toner images carried by the image carriers to the intermediate transfer member; and a second-transfer unit provided on a downstream side relative to the plurality of first-transfer units in the direction of rotation of the intermediate transfer member and configured to transfer the toner images on the intermediate transfer member to a medium.

### BRIEF DESCRIPTION OF THE DRAWINGS

Exemplary embodiments of the present disclosure will be described in detail based on the following figures, wherein:

FIG. 1 schematically illustrates an image forming apparatus according to a first exemplary embodiment;

FIG. 2 is a perspective view of a transferring member included in the image forming apparatus according to the first exemplary embodiment;

FIG. 3 is a perspective view of a fixing device included in the image forming apparatus according to the first exemplary embodiment;

FIG. 4 illustrates toner-image-forming units for cyan and black that are included in the image forming apparatus according to the first exemplary embodiment;

FIG. 5 illustrates a photoconductor and a first-transfer roll that are included in the toner-image-forming unit for black that is included in the image forming apparatus according to the first exemplary embodiment;

FIG. 6 illustrates a section of a part of the photoconductor of the toner-image-forming unit for black included in the image forming apparatus according to the first exemplary embodiment;

FIG. 7A illustrates a section of a part of a photoconductor of a toner-image-forming unit for black included in an image forming apparatus according to a second exemplary embodiment;

FIG. 7B illustrates a section of a part of a photoconductor of any of toner-image-forming units for colors excluding black included in the image forming apparatus according to the second exemplary embodiment;

FIG. 8 is a side view of a photoconductor of a toner-image-forming unit for black included in an image forming apparatus according to a third exemplary embodiment; and

FIG. 9 schematically illustrates an image forming apparatus according to a fourth exemplary embodiment.

### DETAILED DESCRIPTION

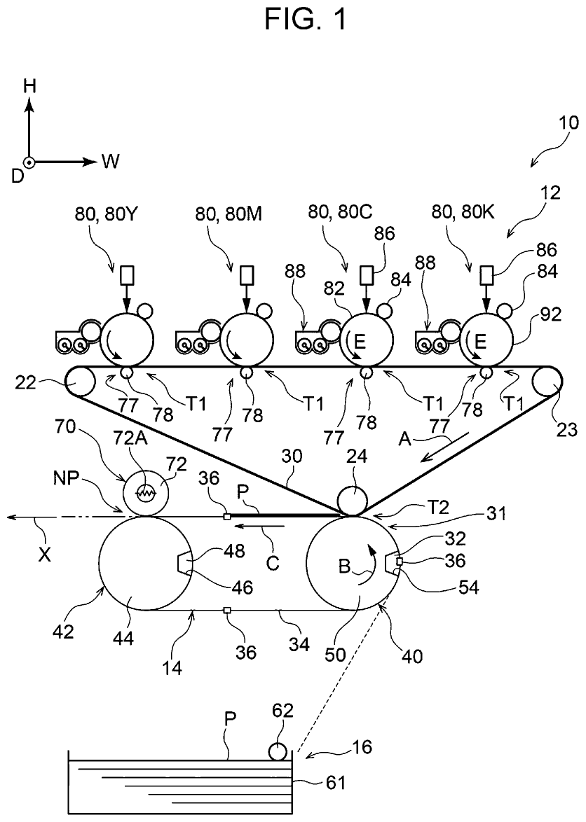

Exemplary embodiments of the present disclosure will now be described in detail with reference to the drawings. As a matter of convenience of description, referring to FIG. 1 and others, arrow H represents the top-bottom direction of an image forming apparatus, arrow W represents the width direction of the image forming apparatus, and arrow D represents the depth direction of the image forming apparatus.

### First Exemplary Embodiment

FIG. 1 schematically illustrates an image forming apparatus 10 according to a first exemplary embodiment. As illustrated in FIG. 1, the image forming apparatus 10 employs, for example, an electrophotographic scheme to form an image on a recording medium P. The image forming apparatus 10 includes an image forming section 12, a transporting section 14, a feed-transporting section 16, and a fixing device 70. The recording medium P is an exemplary medium.

Now, the feed-transporting section 16, the image forming section 12, the transporting section 14, and the fixing device 70 of the image forming apparatus 10 will be described.

### Feed-Transporting Section

The feed-transporting section 16 includes a container 61, in which recording media P are contained; and a feeding roll 62, which is configured to feed the recording media P one by one from the container 61. The feed-transporting section 16 further includes a transporting roll (not illustrated) configured to transport each recording medium P fed from the feeding roll 62 to a transferring member 40, which will be described separately below.

### Image Forming Section

As illustrated in FIG. 1, the image forming section 12 has a function of forming toner images (exemplary images) in different colors on a recording medium P. Specifically, the image forming section 12 includes a plurality of toner-image-forming units 80, which are configured to form toner images (exemplary images) in respective colors; a transfer belt 30, which is an exemplary intermediate transfer member; a driving roll 22; a tension applying roll 23; and a counter roll 24. The image forming section 12 further includes a plurality of first-transfer units 77, which are configured to transfer the toner images formed by the respective toner-image-forming units 80 to the transfer belt 30; and a second-transfer unit 31, which is configured to transfer the toner images on the transfer belt 30 to a recording medium P. The toner-image-forming units 80 are each an exemplary image forming unit.

### Transfer Belt

The transfer belt 30 has an endless shape and is stretched over the driving roll 22, the tension applying roll 23, and the counter roll 24 in such a manner as to form an inverted triangle when seen in the front-rear direction. When the driving roll 22 is rotated, the transfer belt 30 rotates in the direction of arrow A (that is, moves in the peripheral direction). The driving roll 22 is an exemplary driving unit configured to rotate the transfer belt 30. The driving roll 22 is located, in the direction of rotation of the transfer belt 30, on the upstream side relative to the plurality of toner-image-forming units 80 and on the downstream side relative to the counter roll 24. In other words, the driving roll 22 is located at a position in the direction of rotation of the transfer belt 30 that is between the counter roll 24, which is included in the second-transfer unit 31, but the upstreammost one (in the first exemplary embodiment, a toner-image-forming unit 80Y for yellow, which will be described separately below) of the toner-image-forming units 80.

The tension applying roll 23 is configured to apply a tension to the transfer belt 30. The tension applying roll 23 is located, in the direction of rotation of the transfer belt 30, on the downstream side relative to the plurality of toner-image-forming units 80 (in the first exemplary embodiment, a toner-image-forming unit 80K for black, which will be described separately below) but on the upstream side relative to the counter roll 24.

### Toner-Image-Forming Units

The plurality of toner-image-forming units 80 are configured to form toner images in respective colors. In the first exemplary embodiment, the toner-image-forming units 80 are provided for four colors of yellow (Y), magenta (M), cyan (C), and black (K). In FIG. 1, characters of Y, M, C, and K representing the respective colors are added as suffixes to the reference number 80 given to the toner-image-forming units.

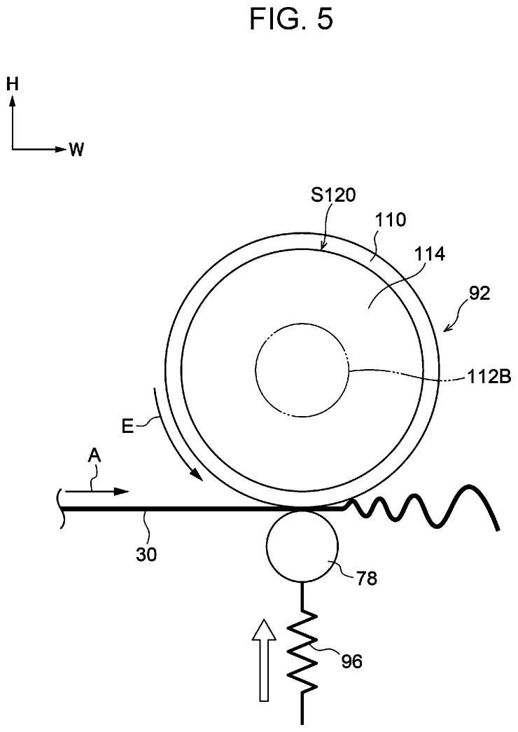

The toner-image-forming units 80 (80Y, 80M, and 80C) for yellow (Y), magenta (M), and cyan (C) include respective photoconductors 82, each of which has a round columnar shape and is configured to rotate in one direction (represented by arrow E). Each of the photoconductors 82 is surrounded by, in order from the upstream side in the direction of rotation thereof, a charging device 84, an exposure device 86, and a developing device 88. The toner-image-forming unit 80K for black (K) includes a photoconductor 92, which has a round columnar shape and is configured to rotate in one in one direction (represented by arrow E). The photoconductor 92 is surrounded by, in order from the upstream side in the direction of rotation thereof, a charging device 84, an exposure device 86, and a developing device 88. The photoconductor 82 and the photoconductor 92 are each an exemplary image carrier. The photoconductor 92 is provided with a moment-of-inertia-increasing structure S120 (see FIG. 5), which increases the moment of inertia of the photoconductor 92 relative to the moments of inertia of the photoconductors 82.

The photoconductors 82 and the photoconductor 92 for the respective colors are in contact with the transfer belt 30. The moment-of-inertia-increasing structure S120 is provided to one of the toner-image-forming units 80 (in the first exemplary embodiment, the toner-image-forming unit 80K for black) that is located at the downstreammost position in the direction of rotation of the transfer belt 30. The moment-of-inertia-increasing structure S120 will be described separately below.

In each of the toner-image-forming units 80 (80Y, 80M, and 80C) for yellow (Y), magenta (M), and cyan (C), the charging device 84 charges the surface of the photoconductor 82, and the exposure device 86 exposes the surface of the photoconductor 82 that has been charged by the charging device 84 to light, whereby an electrostatic latent image is formed on the surface of the photoconductor 82. Furthermore, the developing device 88 develops the electrostatic latent image formed on the surface of the photoconductor 82 by the exposure device 86 into a toner image. Likewise, in the toner-image-forming unit 80K for black (K), the charging device 84 charges the surface of the photoconductor 92, and the exposure device 86 exposes the surface of the photoconductor 92 that has been charged by the charging device 84 to light, whereby an electrostatic latent image is formed on the surface of the photoconductor 92. Furthermore, the developing device 88 develops the electrostatic latent image formed on the surface of the photoconductor 92 by the exposure device 86 into a toner image.

### First-Transfer Units

The first-transfer units 77 include respective first-transfer rolls 78, which are provided on the inner peripheral side of the transfer belt 30 and across the transfer belt 30 from the respective photoconductors 82 and 92 included in the toner-image-forming units 80 for the respective colors. In the first exemplary embodiment, the first-transfer rolls 78 are in contact with the inner peripheral surface of the transfer belt 30. The first-transfer rolls 78 are each an exemplary transfer rotating member. The toner images formed by the toner-image-forming units 80 for the respective colors are sequentially transferred to the transfer belt 30 at respective first-transfer positions T1 by the respective first-transfer rolls 78 in such a manner as to be superposed one on top of another. The set of the superposed toner images is then transferred to a recording medium P in a second-transfer process at a second-transfer position T2, which is defined in the second-transfer unit 31.

### Second-Transfer Unit

The second-transfer unit 31 is located on the downstream side relative to the plurality of first-transfer units 77 in the direction of rotation of the transfer belt 30. The second-transfer unit 31 includes the transferring member 40. The transferring member 40 is located below the transfer belt 30. The transferring member 40 includes, for example, a transferring body 50, which is positioned such that the axial direction thereof is parallel to the axial direction of the counter roll 24. The transferring body 50 is positioned against the transfer belt 30 such that the transfer belt 30 is nipped between the transferring body 50 and the counter roll 24 to define the second-transfer position T2. When a transfer voltage is applied between the counter roll 24 and the transferring body 50 at the second-transfer position T2, the set of the toner images on the transfer belt 30 is transferred to a recording medium P in the second-transfer process.

In FIG. 1, the direction of transport of the recording medium P is represented by arrow X. A cleaner configured to remove residual toner from the transfer belt 30 may be provided at a position, in the direction of rotation of the transfer belt 30, on the downstream side relative to the second-transfer position T2 but on the upstream side relative to the toner-image-forming units 80 (80Y, 80M, 80C, and 80K).

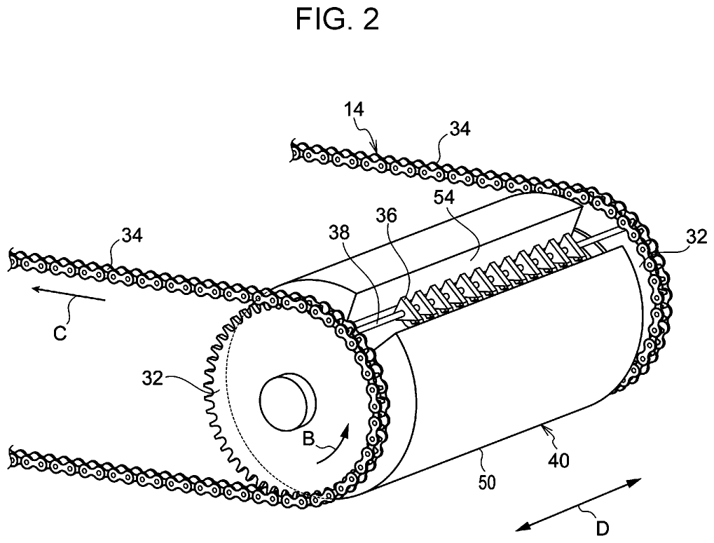

Referring to FIG. 2, the transferring body 50 has in a portion of the outer peripheral surface thereof a recess 54, in which relevant ones of grippers 36 and a relevant one of supporting members 38 are to be positioned. The transferring body 50 is provided at the two axial ends thereof with a pair of sprocket wheels 32. The pair of sprocket wheels 32 are positioned coaxially with the transferring body 50 and are configured to rotate together with the transferring body 50. The transferring body 50 is configured to be rotated by a driving unit (not illustrated). The pair of sprocket wheels 32 support a pair of chains 34, which are wound therearound.

The counter roll 24 is movable by a transfer-process moving mechanism (not illustrated), which includes a cam or the like, between a contacting position where the counter roll 24 is in contact with the transferring body 50 and a retracted position where the counter roll 24 is retracted from the transferring body 50.

### Fixing Device

Referring to FIG. 1, the fixing device 70 is configured to fix the set of the toner images transferred to the recording medium P. Specifically, the fixing device 70 includes a pressing member 42 and a heating roll 72, which are located at a position of the transporting section 14 that is on the downstream side in the direction of transport of the recording medium P.

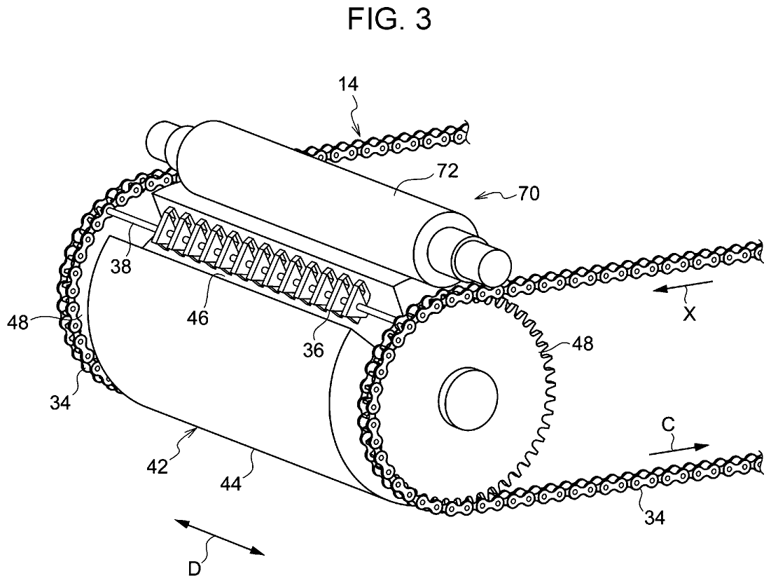

Referring to FIG. 3, the pressing member 42 includes a pressing roll 44, which is positioned such that the axial direction thereof is parallel to the axial direction of the transferring body 50. The pressing roll 44 is provided at the two axial ends thereof with a pair of sprocket wheels 48. The pair of sprocket wheels 48 are positioned coaxially with the pressing roll 44 and are configured to rotate together with the pressing roll 44. The pair of sprocket wheels 48 support the pair of chains 34, which are wound therearound and to be described separately below.

Referring to FIG. 1, the heating roll 72 and the pressing roll 44 are positioned one on top of the other. Specifically, the heating roll 72 is located above the pressing roll 44. The heating roll 72 includes thereinside a heat source 72A, which is a halogen lamp or the like. Hereinafter, the position where the heating roll 72 and the pressing roll 44 nip the recording medium P therebetween is referred to as nipping position NP.

The heating roll 72 is movable by a fixing-process moving mechanism (not illustrated), which includes a cam or the like, between a contacting position where the heating roll 72 is in contact with the pressing roll 44 and a retracted position where the heating roll 72 is retracted from the pressing roll 44. When the heating roll 72 is at the contacting position, the heating roll 72 and the pressing roll 44 are capable of nipping the recording medium P.

The pressing roll 44 has in a portion of the outer peripheral surface thereof a recess 46, in which relevant ones of the grippers 36, to be described below, and a relevant one of the supporting member 38 are to be positioned.

### Transporting Section

Referring to FIGS. 1 to 3, the transporting section 14 has a function of transporting the recording medium P in such a manner as to pass the recording medium P through the second-transfer position T2 and the nipping position NP. The transporting section 14 includes the pair of chains 34 and the grippers 36. The pair of chains 34 are intended to transmit a rotational driving force generated by the transferring body 50 to the pressing roll 44. The grippers 36 are intended to grip the leading end of the recording medium P. The illustration of the chains 34 and the grippers 36 in FIG. 1 is simplified.

As illustrated in FIG. 1, the pair of chains 34 each have an annular shape. As illustrated in FIG. 2, the pair of chains 34 are positioned at an interval therebetween in the depth direction of the image forming apparatus 10 (hereinafter referred to as apparatus-depth direction). The pair of chains 34 are wound around the pair of sprocket wheels 32 coaxially provided on the transferring body 50, and around the pair of sprocket wheels 48 coaxially provided on the pressing roll 44.

When the transferring body 50 is rotated by the driving unit (not illustrated), the pair of sprocket wheels 32 rotate together with the transferring body 50 in a rotating direction B (represented by arrow B), whereby the chains 34 circulate in a circulating direction C (represented by arrow C). Accordingly, the pressing roll 44 rotates by following the chains 34. That is, the pair of chains 34 that circulate in the circulating direction C (see FIG. 1) transmit the rotational driving force generated by the transferring body 50 to the pressing roll 44.

Referring to FIGS. 2 and 3, the pair of chains 34 are provided with the supporting members 38, which are provided with the grippers 36 and each extend in the apparatus-depth direction from one of the chains 34 to the other. The supporting members 38 (three supporting members 38 are provided in the case illustrated in FIG. 1) are fixed to the pair of chains 34 at predetermined intervals in the peripheral direction (circulating direction C) of the chains 34.

Each of the supporting members 38 is provided with a plurality of the grippers 36 that are arranged at predetermined intervals in the apparatus-depth direction. That is, the grippers 36 are attached to the chains 34 with the aid of the supporting members 38. The grippers 36 each have a function of gripping the leading end of the recording medium P.

The grippers 36 include a plurality of catches and a plurality of catch receivers (both not illustrated). The grippers 36 grip the recording medium P such that the leading end of the recording medium P is held between each of the catches and a corresponding one of the catch receivers.

The grippers 36 are to be located on the downstream side relative to the recording medium P in the direction of transport of the recording medium P so as to receive the leading end of the recording medium P from the downstream side in the direction of transport of the recording medium P.

Thus, in the transporting section 14, the leading end of the recording medium P transported from the feed-transporting section 16 is to be gripped by the grippers 36. In the transporting section 14, when the chains 34 are made to circulate in the direction of arrow C with relevant ones of the grippers 36 gripping the leading end of the recording medium P, the grippers 36 gripping the recording medium P move in such a manner as to cause the recording medium P to pass through the second-transfer position T2 together with the grippers 36.

In an area where the chains 34 run along the sprocket wheels 32, relevant ones of the grippers 36 are positioned in the recess 54 provided in the transferring body 50 and move together with the transferring body 50 in the direction of rotation of the transferring body 50. Likewise, in an area where the chains 34 run along the sprocket wheels 48, relevant ones of the grippers 36 are positioned in the recess 46 provided in the pressing roll 44 and move together with the pressing roll 44 in the direction of rotation of the pressing roll 44.

In the transporting section 14, while the heating roll 72 is at the retracted position, the recording medium P is transported to the nipping position NP with the grippers 36 gripping the leading end of the recording medium P. When the recording medium P reaches the nipping position NP in the transporting section 14 and the heating roll 72 is moved to the contacting position, the leading end of the recording medium P is released. Specifically, the transporting section 14 is configured such that the gripping of the leading end of the recording medium P is disabled after the grippers 36 pass through the nipping position NP.

Thus, in the fixing device 70, while the recording medium P nipped between the heating roll 72 and the pressing roll 44 is transported, heat and pressure are applied to the recording medium P, whereby the set of the toner images transferred to the recording medium P is fixed.

### Configuration of Downstreammost Toner-Image-Forming Unit

A configuration of one of the toner-image-forming units 80 that is located at the downstreammost position in the direction of rotation of the transfer belt 30 will now be described as a feature of the image forming apparatus 10 according to the first exemplary embodiment of the present disclosure. In the first exemplary embodiment, the toner-image-forming unit 80 located at the downstreammost position in the direction of rotation of the transfer belt 30 is the toner-image-forming unit 80K for black, a configuration of which will be described.

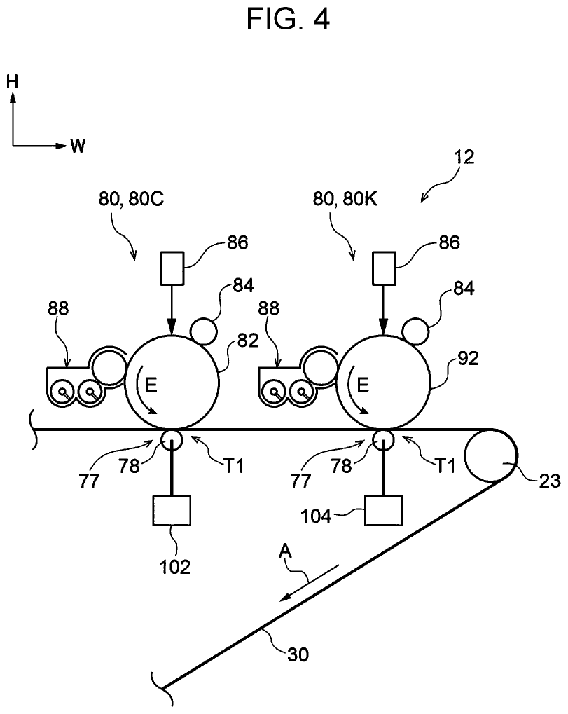

Referring to FIGS. 1 and 4, the toner-image-forming unit 80K for black includes the photoconductor 92 as described above, and the transfer belt 30 is nipped between the photoconductor 92 and a corresponding one of the first-transfer rolls 78. The photoconductor 92 has a cylindrical shape with an outside diameter that is substantially equal to the outside diameters of the photoconductors 82 of the other toner-image-forming units 80 (80Y, 80M, and 80C). Herein, the expression “substantially equal to” implies “smaller than or equal to”. With reference to the outside diameter of each photoconductor 82, the outside diameter of the photoconductor 92 may preferably be within a range of ±10%, more preferably ±5%, much more preferably ±1%.

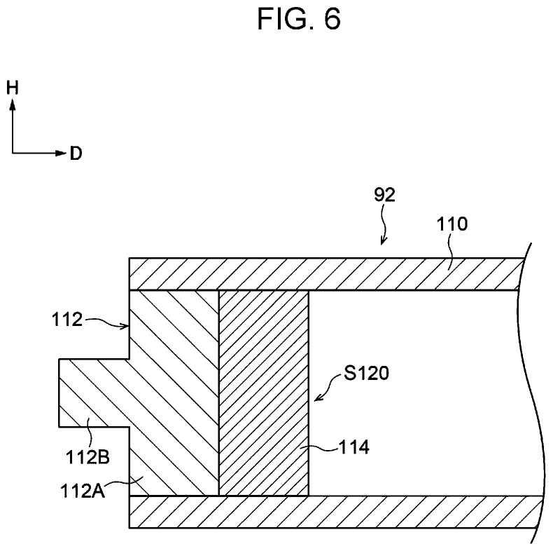

Referring to FIGS. 5 and 6, as described above, the photoconductor 92 is provided with the moment-of-inertia-increasing structure S120 that increases the moment of inertia of the photoconductor 92 relative to the moments of inertia of the photoconductors 82.

The photoconductor 92 includes, for example, a cylindrical member 110 and fitted members 112, which are fitted to the two respective axial ends of the cylindrical member 110 (see FIG. 6). FIG. 6 illustrates one of the two axial ends of the photoconductor 92 and does not illustrate the other axial end, which has the same configuration as the one axial end. The fitted members 112 each include a circular base 112A, which is in contact with the inner peripheral surface of the cylindrical member 110; and a shaft 112B, which extends axially outward from a portion of the base 112A that contains the center of the base 112A. The moment-of-inertia-increasing structure S120 is obtained as a weight 114, which is provided inside the cylindrical member 110 in such a manner as to rotate together with the cylindrical member 110. The weight 114 is, for example, a circular plate and is in contact with the inner surface of the cylindrical member 110. A lateral face of the weight 114 is in contact with the base 112A. The weight 114 may be bonded to one of the cylindrical member 110 and the base 112A or to both the cylindrical member 110 and the base 112A.

The photoconductors 82 (not illustrated in detail) of the other toner-image-forming units 80 (80Y, 80M, and 80C) include no weights 114. The details of the photoconductor 92 other than the weight 114 are the same as those of the photoconductors 82 of the other toner-image-forming units 80 (80Y, 80M, and 80C).

Since the photoconductor 92 includes the weight 114, the photoconductor 92 exhibits a greater moment of inertia than the photoconductors 82 of the other toner-image-forming units 80 (80Y, 80M, and 80C). The moment of inertia is an index expressing the easiness in moving a rotatable body. Specifically, the moment of inertia is a physical quantity indicating the force with which a rotatable body tends to keep being in the current position, that is, how difficult it is to rotate the rotatable body. The greater the moment of inertia, the greater energy required for acceleration. For example, the moment of inertia of the photoconductor 92 may preferably be greater by 50% than the moments of inertia of the photoconductors 82, more preferably greater by 100%, much more preferably greater by 200%.

Referring to FIG. 4, the first-transfer roll 78 provided for the toner-image-forming unit 80C for cyan is connected to a power source 102, which is configured to apply a transfer bias between the first-transfer roll 78 and the photoconductor 82. Likewise, the first-transfer rolls 78 provided for the toner-image-forming units 80Y and 80M for yellow and magenta are also connected to respective power sources 102 (not illustrated). The photoconductors 82 are grounded. The first-transfer roll 78 provided for the toner-image-forming unit 80K for black is connected to a power source 104, which is configured to apply a transfer bias between the first-transfer roll 78 and the photoconductor 92. The photoconductor 92 is grounded.

The power sources 102 and the power source 104 are different from each other in the value of the transfer bias to be set. The value that is set as the transfer bias to be applied by the power source 104 is greater than the values that are set as the transfer biases to be applied by the power sources 102. That is, the transfer bias to be applied between the first-transfer roll 78 and the photoconductor 92 of the toner-image-forming unit 80K for black located at the downstreammost position in the direction of rotation of the transfer belt 30 is greater than the transfer bias to be applied between each of the other first-transfer rolls 78 and a corresponding one of the photoconductors 82 of the other toner-image-forming units 80Y, 80M, and 80C. For example, the transfer bias to be applied between the first-transfer roll 78 and the photoconductor 92 may preferably be greater by 30% than the transfer bias to be applied between each of the other first-transfer rolls 78 and a corresponding one of the photoconductors 82, more preferably greater by 50%, much more preferably greater by 100%.

Referring to FIG. 5, the first-transfer roll 78 is pressed against the photoconductor 92 by an urging member 96 with the transfer belt 30 interposed therebetween. The urging member 96 is, for example, a spring such as a coil spring. The force of pressing the first-transfer roll 78 against the photoconductor 92 of the toner-image-forming unit 80K for black by the urging member 96 is greater than the force of pressing each of the other first-transfer rolls 78 against a corresponding one of the photoconductors 82 of the other toner-image-forming units 80Y, 80M, and 80C by a corresponding one of urging members (not illustrated). That is, the load to be applied to the nip between the photoconductor 92 of the toner-image-forming unit 80K for black located at the downstreammost position in the direction of rotation of the transfer belt 30 and the corresponding first-transfer roll 78 is greater than the load to be applied to the nip between each of the photoconductors 82 of the other toner-image-forming units 80Y, 80M, and 80C and a corresponding one of the first-transfer rolls 78. For example, the load to be applied to the nip between the photoconductor 92 and the corresponding first-transfer roll 78 may preferably be set to a value 1.5 or more times the load to be applied to the nip between each of the photoconductors 82 and the corresponding first-transfer roll 78, more preferably a value 2 or more times the load to be applied to the nip between the photoconductor 82 and the first-transfer roll 78, much more preferably a value 3 or more times the load to be applied to the nip between the photoconductor 82 and the first-transfer roll 78.

### Problems in Image Forming Apparatus According to Comparative Embodiment

Now, problems in an image forming apparatus according to a comparative embodiment will be discussed.

An image forming apparatus according to a comparative embodiment (not illustrated) includes toner-image-forming units that are provided for four respective colors of, in order in the direction of rotation of a transfer belt, yellow; magenta; cyan; and black, and from which toner images in the four respective colors are transferred to the transfer belt at respective first-transfer positions in such a manner as to be superposed one on top of another. The set of the toner images superposed on the transfer belt is further transferred to a recording medium P at a second-transfer position. In the image forming apparatus according to the comparative embodiment, the configuration of the toner-image-forming unit for black is the same as those of the toner-image-forming units for the other colors (yellow, magenta, and cyan). That is, the photoconductor of the toner-image-forming unit for black is provided with no moment-of-inertia-increasing structure such as the one employed in the first exemplary embodiment.

In the image forming apparatus according to the comparative embodiment, vibrations of the transfer belt that occur at the second-transfer position may be propagated to the first-transfer positions, which are defined on the upstream side in the direction of rotation of the transfer belt. In a large-size image forming apparatus (for example, an apparatus intended for high-speed transport or for long-size recording media P), impulse vibrations occurring at the second-transfer position particularly tend to be greater than in a small-size image forming apparatus, leading to an increase in the vibrations propagated to the transfer belt. For example, in a configuration where the recording medium is to be transported by grippers, a recess is provided in a portion of a transferring body in the peripheral direction so as to prevent the interference between the second-transfer unit and the grippers that may occur when the grippers pass along the second-transfer unit. When the recess of the transferring body reaches or passes through the second-transfer unit, an impact load occurs and is propagated as a large vibration to the transfer belt. Such a vibration fluctuates the nipped portion of the transfer belt at the first-transfer unit provided for one of the plurality of toner-image-forming units that is located at the downstreammost position in the direction of rotation of the transfer belt, leading to nonuniformity in the density of the image transferred from the photoconductor to the transfer belt.

### Functions of First Exemplary Embodiment

Functions provided by the first exemplary embodiment are summarized as follows.

The image forming apparatus 10 includes the plurality of toner-image-forming units 80 configured to form respective toner images in different colors, and the endless-shaped transfer belt 30 that is rotatable in the peripheral direction thereof. The image forming apparatus 10 further includes the plurality of first-transfer units 77 provided at positions across from the respective toner-image-forming units 80 and configured to transfer the toner images formed by the toner-image-forming units 80 to the transfer belt 30. The image forming apparatus 10 further includes the second-transfer unit 31 provided on the downstream side relative to the plurality of first-transfer units 77 in the direction of rotation of the transfer belt 30 and configured to transfer the toner images on the transfer belt 30 to a recording medium P. The photoconductor 92 of the toner-image-forming unit 80K for black that is located at the downstreammost position in the direction of rotation of the transfer belt 30 is provided with the moment-of-inertia-increasing structure S120 that increases the moment of inertia of the photoconductor 92 relative to the moments of inertia of the photoconductors 82 of the other toner-image-forming units 80. That is, the moment of inertia of the photoconductor 92 of the downstreammost toner-image-forming unit 80K for black is greater than the moments of inertia of the photoconductors 82 of the other toner-image-forming units 80.

In the above configuration, the force of gripping the transfer belt 30 by the photoconductor 92 of the downstreammost toner-image-forming unit 80K and the corresponding first-transfer roll 78 is greater than the force of gripping the transfer belt 30 by each of the photoconductors 82 and the corresponding first-transfer roll 78. Accordingly, the vibrations of the transfer belt 30 occurring in the second-transfer unit 31 are less likely to fluctuate the nipped portion of the transfer belt 30 at the first-transfer unit 77 provided for the downstreammost toner-image-forming unit 80K. Such a reduction in the fluctuation of the nipped portion of the transfer belt 30 at the first-transfer unit 77 provided for the downstreammost toner-image-forming unit 80K is particularly pronounced for the fluctuation caused by the impact load occurring when the recess 54 of the transferring body 50 reaches or passes through the second-transfer unit 31.

The photoconductors 82 and the photoconductor 92 have cylindrical shapes with outside diameters that are equal to one another.

The moment-of-inertia-increasing structure S120 is obtained as the weight 114 provided inside the cylindrical member 110 of the photoconductor 92 of the downstreammost toner-image-forming unit 80K in such a manner as to rotate together with the cylindrical member 110.

The load to be applied to the nip between the photoconductor 92 of the downstreammost toner-image-forming unit 80K and the corresponding first-transfer roll 78 is greater than the load to be applied to the nip between each of the photoconductors 82 of the other toner-image-forming units 80 (80Y, 80M, and 80C) and the corresponding first-transfer roll 78. In such a configuration, the force of gripping the transfer belt 30 by the photoconductor 92 of the downstreammost toner-image-forming unit 80K and the corresponding first-transfer roll 78 is greater than that exerted by each of the other toner-image-forming units 80. Accordingly, the vibrations of the transfer belt 30 occurring in the second-transfer unit 31 are less likely to fluctuate the nipped portion of the transfer belt 30 at the first-transfer unit 77 provided for the downstreammost toner-image-forming unit 80K.

The transfer bias to be applied between the photoconductor 92 of the downstreammost toner-image-forming unit 80K and the corresponding first-transfer roll 78 is greater than the transfer bias to be applied between each of the photoconductors 82 of the other toner-image-forming units 80 (80Y, 80M, and 80C) and the corresponding first-transfer roll 78. In such a configuration, the adhesion between the transfer belt 30 and the first-transfer roll 78 for the photoconductor 92 is increased, which reduces the probability of slipping between the transfer belt 30 and the first-transfer roll 78 and increases the force of gripping the transfer belt 30 by the photoconductor 92 and the first-transfer roll 78. Accordingly, the vibrations of the transfer belt 30 occurring in the second-transfer unit 31 are less likely to fluctuate the nipped portion of the transfer belt 30 at the first-transfer unit 77 provided for the downstreammost toner-image-forming unit 80K.

The driving roll 22 configured to drive the transfer belt 30 is provided at a position between the second-transfer unit 31 and the photoconductor 82 of the upstreammost toner-image-forming unit 80Y in the direction of rotation of the transfer belt 30. In such a configuration, the transfer belt 30 is less likely to expand or contract between the toner-image-forming unit 80C for cyan and the toner-image-forming unit 80K for black, reducing the misalignment between the toner images in the different colors.

### Second Exemplary Embodiment

An image forming apparatus according to a second exemplary embodiment will now be described. Elements that are the same as those described in the first exemplary embodiment are denoted by the same reference signs, and description of such elements is omitted.

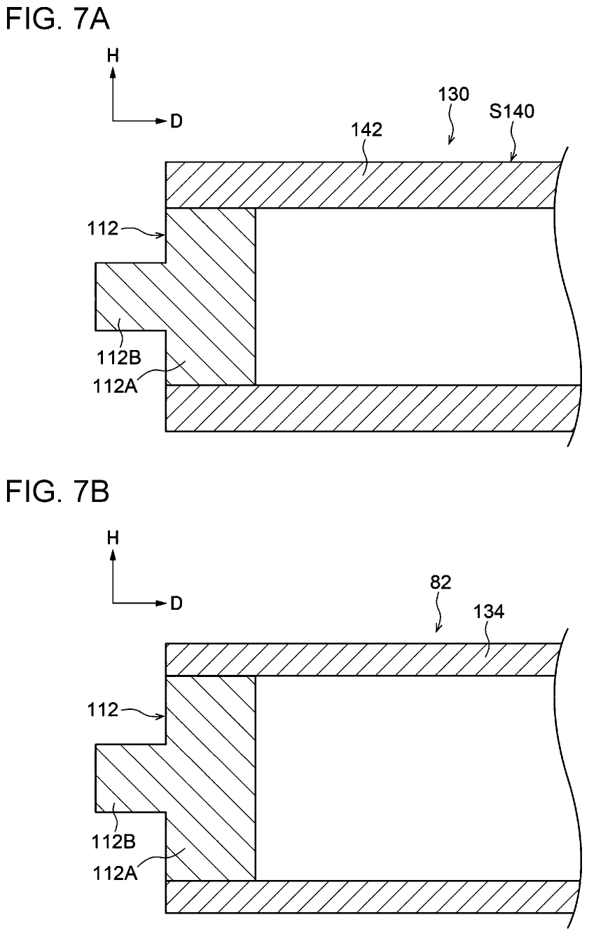

Referring to FIG. 7A, in the image forming apparatus according to the second exemplary embodiment, the toner-image-forming unit 80K located at the downstreammost position in the direction of rotation of the transfer belt 30 includes a photoconductor 130. The photoconductor 130 is provided with a moment-of-inertia-increasing structure S140, which increases the moment of inertia of the photoconductor 130 relative to the moments of inertia of the photoconductors 82 of the other toner-image-forming units 80 (80Y, 80M, and 80C).

The photoconductor 130 includes a cylindrical member 142. Referring to FIGS. 7A and 7B, the moment-of-inertia-increasing structure S140 is obtained by making the thickness of the cylindrical member 142 of the photoconductor 130 greater than the thicknesses of cylindrical members 134 of the photoconductors 82. For example, the thickness of the cylindrical member 142 of the photoconductor 130 may preferably be greater by 100% than the thicknesses of the cylindrical members 134 of the photoconductors 82, more preferably greater by 300%, much more preferably greater by 500%. The other details of the image forming apparatus according to the second exemplary embodiment are the same as those of the image forming apparatus 10 according to the first exemplary embodiment.

The image forming apparatus according to the second exemplary embodiment provides the following functions, in addition to the functions provided by the elements that are the same as those of the image forming apparatus 10 according to the first exemplary embodiment.

The moment-of-inertia-increasing structure S140 is obtained by making the thickness of the cylindrical member 142 of the photoconductor 130 greater than the thicknesses of the cylindrical members 134 of the photoconductors 82.

### Third Exemplary Embodiment

An image forming apparatus according to a third exemplary embodiment will now be described. Elements that are the same as those described in the first and second exemplary embodiments are denoted by the same reference signs, and description of such elements is omitted.

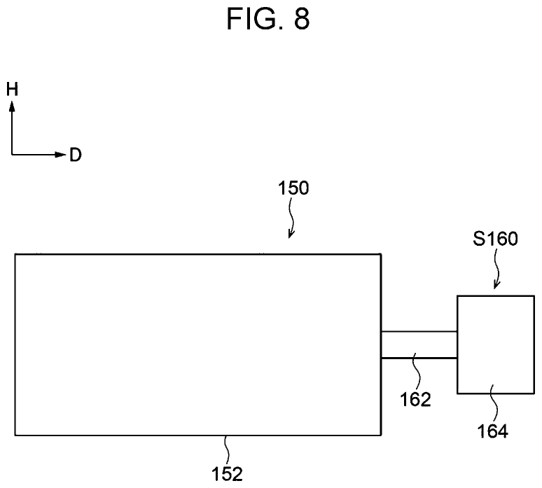

Referring to FIG. 8, in the image forming apparatus according to the third exemplary embodiment, the toner-image-forming unit 80K located at the downstreammost position in the direction of rotation of the transfer belt 30 includes a photoconductor 150. The photoconductor 150 is provided with a moment-of-inertia-increasing structure S160, which increases the moment of inertia of the photoconductor 150 relative to the moments of inertia of the photoconductors 82 of the other toner-image-forming units 80 (80Y, 80M, and 80C).

The moment-of-inertia-increasing structure S160 is obtained as a weight 164, which is provided coaxially with a cylindrical member 152 of the photoconductor 150 but outside the cylindrical member 152 in the axial direction in such a manner as to rotate together with the cylindrical member 152. For example, the moment-of-inertia-increasing structure S160 includes a shaft 162, which extends in the axial direction of the cylindrical member 152 of the photoconductor 150 from one axial end of the cylindrical member 152 and is provided with the weight 164 at the distal end thereof. The weight 164 is, for example, a round columnar member, with the shaft 162 joined to a central portion thereof. The other details of the image forming apparatus according to the third exemplary embodiment are the same as those of the image forming apparatus 10 according to the first exemplary embodiment.

The image forming apparatus according to the third exemplary embodiment provides the following functions, in addition to the functions provided by the elements that are the same as those of the image forming apparatus 10 according to the first exemplary embodiment.

The moment-of-inertia-increasing structure S160 is obtained as the weight 164 provided coaxially with the cylindrical member 152 of the photoconductor 150 but outside the cylindrical member 152 in the axial direction in such a manner as to rotate together with the cylindrical member 152.

### Fourth Exemplary Embodiment

An image forming apparatus according to a fourth exemplary embodiment will now be described. Elements that are the same as those described in the first to third exemplary embodiments are denoted by the same reference signs, and description of such elements is omitted.

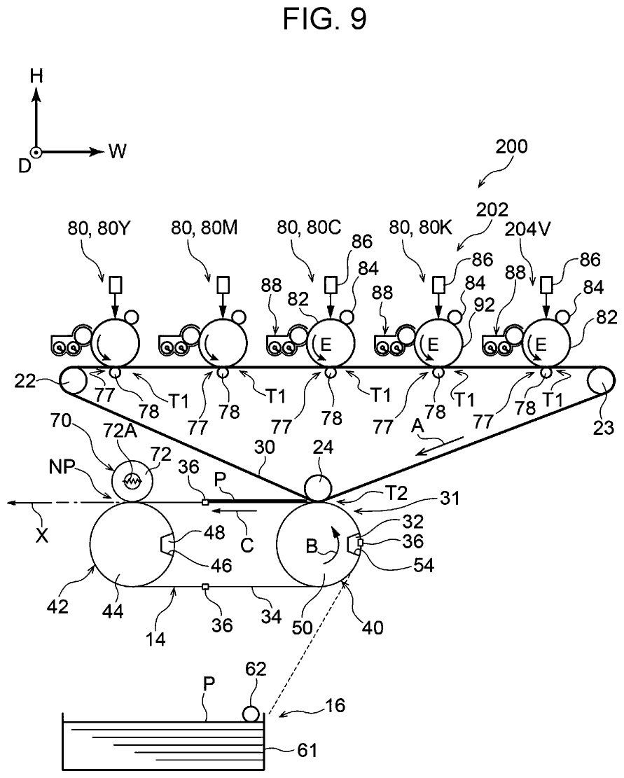

Referring to FIG. 9, an image forming apparatus 200 includes an image forming section 202. The image forming section 202 includes the toner-image-forming units 80Y, 80M, 80C, and 80K for four colors configured to form respective toner images in four respective colors of yellow (Y), magenta (M), cyan (C), and black (K) that are to be combined into a color image; and a special-color toner-image-forming unit 204V, which is configured to form a toner image in a special color (V). The special-color toner-image-forming unit 204V is an exemplary special-color image forming unit. The special-color toner-image-forming unit 204V is located, in the direction of rotation of the transfer belt 30, on the downstream side relative to the plurality of toner-image-forming units 80 (80Y, 80M, 80C, and 80K) but on the upstream side relative to the second-transfer unit 31.

The special-color toner-image-forming unit 204V includes a photoconductor 82, which is configured to rotate in one direction (represented by arrow E) and is surrounded by, in order from the upstream side in the direction of rotation thereof, a charging device 84, an exposure device 86, and a developing device 88. The photoconductor 82 of the special-color toner-image-forming unit 204V has the same configuration as the photoconductors 82 of the toner-image-forming units 80Y, 80M, and 80C. That is, the photoconductor 82 of the special-color toner-image-forming unit 204V is provided with no moment-of-inertia-increasing structure.

Among the toner-image-forming units 80Y, 80M, 80C, and 80K for four colors configured to form respective toner images in the four respective colors of yellow (Y), magenta (M), cyan (C), and black (K) that are to be combined into a color image, the toner-image-forming unit 80K located at the downstreammost position in the direction of rotation of the transfer belt 30 includes the photoconductor 92 provided with the moment-of-inertia-increasing structure S120 (see FIG. 6), as described above. In other words, among the four toner-image-forming units 80 and excluding the special-color toner-image-forming unit 204V, the toner-image-forming unit 80K located at the downstreammost position in the direction of rotation of the transfer belt 30 includes the photoconductor 92 provided with the moment-of-inertia-increasing structure S120 that increases the moment of inertia of the photoconductor 92 relative to the moments of inertia of the photoconductors 82. Hence, “the image carrier included in the image forming unit at the downstreammost position” according to the present disclosure is the photoconductor 92 included in the downstreammost one of the toner-image-forming units 80 provided for the four colors and excluding the special-color toner-image-forming unit 204V. The other details of the image forming apparatus 200 are the same as those of the image forming apparatus 10 according to the first exemplary embodiment.

The image forming apparatus 200 according to the fourth exemplary embodiment provides the following functions, in addition to the functions provided by the elements that are the same as those of the image forming apparatus 10 according to the first exemplary embodiment.

In the image forming apparatus 200, among the toner-image-forming units 80 for the four colors and excluding the special-color toner-image-forming unit 204V, the toner-image-forming unit 80K located at the downstreammost position in the direction of rotation of the transfer belt 30 includes the photoconductor 92 provided with the moment-of-inertia-increasing structure S120 that increases the moment of inertia of the photoconductor 92 relative to the moments of inertia of the photoconductors 82. In many cases, for example, the special-color toner-image-forming unit 204V configured to form a toner image in the special color is used for forming a solid image having a toner density of 100%. Since nonuniformity in image density tends to occur in halftone toner images (for example, a toner image having a toner density of 20%), the toner image in the special color is less likely to cause nonuniformity in image density. Therefore, in the image forming apparatus 200, the moment-of-inertia-increasing structure S120 is provided to the photoconductor 92 of the toner-image-forming unit 80K located at the downstreammost position in the direction of rotation of the transfer belt 30 among the toner-image-forming units 80 for the four colors and excluding the special-color toner-image-forming unit 204V.

In the image forming apparatus 200, “the image carrier included in the image forming unit at the downstreammost position” according to the present disclosure is the photoconductor 92 of the downstreammost one of the toner-image-forming units 80 provided for the four colors and excluding the special-color toner-image-forming unit 204V.

### Modifications

The present disclosure is not limited to the above exemplary embodiments. Any design changes may be made to the present disclosure without departing from the essence of the present disclosure.

While the first to fourth exemplary embodiments each relate to a case where the second-transfer unit 31 includes the transferring body 50, the present disclosure is not limited to such an embodiment. For example, the configuration including the transferring body 50, the chains 34, and the grippers 36 may be replaced with a configuration including a second-transfer roll that presses the transfer belt against the counter roll. In such a configuration, the recording medium is transported to the nip between the transfer belt and the second-transfer roll, and the toner image on the transfer belt is transferred to a recording medium by using a transfer voltage applied between the counter roll and the second-transfer roll.

While the fourth exemplary embodiment relates to a case where the moment-of-inertia-increasing structure S120 is provided to the photoconductor 92 of the toner-image-forming unit 80K located at the downstreammost position in the direction of rotation of the transfer belt 30 among the toner-image-forming units 80Y, 80M, 80C, and 80K for the four colors, the present disclosure is not limited to such an embodiment. Another moment-of-inertia-increasing structure may be provided to the photoconductor of any one of the toner-image-forming units 80Y, 80M, 80C, and 80K for the four colors that is located at the downstreammost position in the direction of rotation of the transfer belt 30. For example, the photoconductor of the downstreammost one of the toner-image-forming units 80Y, 80M, 80C, and 80K for the four colors may be provided with the moment-of-inertia-increasing structure S140 according to the second exemplary embodiment or the moment-of-inertia-increasing structure S160 according to the third exemplary embodiment.

While the fourth exemplary embodiment relates to a case where the special-color toner-image-forming unit 204V is provided on the downstream side relative to the toner-image-forming units 80Y, 80M, 80C, and 80K for the four colors (that is, at the downstreammost position) in the direction of rotation of the transfer belt 30, the present disclosure is not limited to such an embodiment. The position of the special-color toner-image-forming unit 204V may be changed. For example, the special-color toner-image-forming unit 204V may be provided on the upstream side relative to the plurality of toner-image-forming units 80 (that is, at the upstreammost position) in the direction of rotation of the transfer belt 30 or may be provided between any two of the plurality of toner-image-forming units 80 in the direction of rotation of the transfer belt 30. Moreover, the special-color toner-image-forming unit 204V may be provided on each of the upstream side and the downstream side relative to the plurality of toner-image-forming units 80 (that is, at each of the upstreammost position and the downstreammost position) in the direction of rotation of the transfer belt 30. In such a case, the moment-of-inertia-increasing structure S120 may be provided to the photoconductor of a downstreammost one of the toner-image-forming units 80Y, 80M, 80C, and 80K for the four colors in the direction of rotation of the transfer belt 30 excluding the special-color toner-image-forming units 204V.

While the above exemplary embodiments each relates to a case where the toner image taken as an exemplary image is to be formed by dry electrophotography, the image is not limited to such a toner image. For example, the image may be a toner image to be formed by wet electrophotography.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((0)))

An image forming apparatus comprising:

a plurality of image forming units configured to form respective toner images in different colors;

an endless-shaped intermediate transfer member that is rotatable in a peripheral direction of the intermediate transfer member and to which the toner images are to be sequentially transferred from the plurality of image forming units;

a moment-of-inertia-increasing structure provided to one of rotatable image carriers that are included in the respective image forming units, the moment-of-inertia-increasing structure increasing a moment of inertia of the one image carrier relative to moments of inertia of other ones of the image carriers, the one image carrier being included in one of the image forming units that is located at a downstreammost position in a direction of rotation of the intermediate transfer member, the image carriers being in contact with the intermediate transfer member and configured to carry the respective toner images;

a plurality of first-transfer units provided at positions across from the respective image carriers and configured to transfer the toner images carried by the image carriers to the intermediate transfer member; and

a second-transfer unit provided on a downstream side relative to the plurality of first-transfer units in the direction of rotation of the intermediate transfer member and configured to transfer the toner images on the intermediate transfer member to a medium.

(((2)))

An image forming apparatus comprising:

image forming units for four colors configured to form respective toner images in respective colors of yellow, magenta, cyan, and black that are to be combined into a color image;

a special-color image forming unit configured to form a toner image in a special color;

an endless-shaped intermediate transfer member that is rotatable in a peripheral direction of the intermediate transfer member and to which the toner images are to be sequentially transferred from the image forming units for the four colors and the special-color image forming unit;

a moment-of-inertia-increasing structure provided to one of rotatable image carriers that are included in the respective image forming units including the image forming units for the four respective colors and the special-color image forming unit, the moment-of-inertia-increasing structure increasing a moment of inertia of the one image carrier relative to moments of inertia of other ones of the image carriers, the one image carrier being included in one of the image forming units for the four respective colors that is located at a downstreammost position in a direction of rotation of the intermediate transfer member excluding the special-color image forming unit, the image carriers being in contact with the intermediate transfer member and configured to carry the respective toner images;

a plurality of first-transfer units provided at positions across from the respective image carriers and configured to transfer the toner images carried by the image carriers to the intermediate transfer member; and

a second-transfer unit provided on a downstream side relative to the plurality of first-transfer units in the direction of rotation of the intermediate transfer member and configured to transfer the toner images on the intermediate transfer member to a medium.

(((3)))

The image forming apparatus according to (((1))),

wherein the plurality of image forming units are image forming units for four colors configured to form respective toner images in respective colors of yellow, magenta, cyan, and black that are to be combined into a color image,

wherein the image forming apparatus further includes a special-color image forming unit configured to form a toner image in a special color, the special-color image forming unit being provided on a downstream side relative to the plurality of image forming units for the four colors but on an upstream side relative to the second-transfer unit in the direction of rotation of the intermediate transfer member, and

wherein the image carrier included in the image forming unit at the downstreammost position is the image carrier included in a downstreammost one of the image forming units provided for the four colors and excluding the special-color image forming unit.

(((4)))

The image forming apparatus according to any one of (((1))) to (((3))),

wherein the image carriers have cylindrical shapes with outside diameters that are substantially equal to one another.

(((5)))

The image forming apparatus according to any one of (((1))) to (((4))),

wherein the moment-of-inertia-increasing structure is obtained as a weight provided inside a cylindrical member included in the image carrier of the image forming unit at the downstreammost position, the weight being provided in such a manner as to rotate together with the cylindrical member.

(((6)))

The image forming apparatus according to any one of (((1))) to (((4))),

wherein the moment-of-inertia-increasing structure is obtained by making a thickness of a cylindrical member included in the image carrier of the image forming unit at the downstreammost position greater than thicknesses of cylindrical members included in other ones of the image carriers.

(((7)))

The image forming apparatus according to any one of (((1))) to (((4))),

wherein the moment-of-inertia-increasing structure is obtained as a weight provided coaxially with a cylindrical member included in the image carrier of the image forming unit at the downstreammost position, the weight being provided outside the cylindrical member in an axial direction and in such a manner as to rotate together with the cylindrical member.

(((8)))

The image forming apparatus according to any one of (((1))) to (((7))),

wherein the first-transfer units include respective transfer rotating members that are in contact with an inner peripheral surface of the intermediate transfer member, and

wherein a load to be applied to a nip between the image carrier of the image forming unit at the downstreammost position and a corresponding one of the transfer rotating members is greater than a load to be applied to a nip between each of the image carriers of other ones of the image forming units and a corresponding one of the transfer rotating members.

(((9)))

The image forming apparatus according to any one of (((1))) to (((8))),

wherein the first-transfer units include respective transfer rotating members that are in contact with an inner peripheral surface of the intermediate transfer member, and

wherein a transfer bias to be applied between the image carrier of the image forming unit at the downstreammost position and a corresponding one of the transfer rotating members is greater than a transfer bias to be applied between each of the image carriers of other ones of the image forming units and a corresponding one of the transfer rotating members.

(((10)))

The image forming apparatus according to any one of (((1))) to (((9))), further comprising:

a driving unit configured to drive the intermediate transfer member and provided at a position between the second-transfer unit and one of the image carriers that is located at an upstreammost position in the direction of rotation of the intermediate transfer member.

What is claimed is:

1. An image forming apparatus comprising:
a plurality of image forming units configured to form respective toner images in different colors;
an endless-shaped intermediate transfer member that is rotatable in a peripheral direction of the intermediate transfer member and to which the toner images are to be sequentially transferred from the plurality of image forming units;
a moment-of-inertia-increasing structure provided to one of rotatable image carriers that are included in the respective image forming units, the moment-of-inertia-increasing structure increasing a moment of inertia of the one image carrier relative to moments of inertia of other ones of the image carriers, the one image carrier being included in one of the image forming units that is located at a downstreammost position in a direction of rotation of the intermediate transfer member, the image carriers being in contact with the intermediate transfer member and configured to carry the respective toner images;
a plurality of first-transfer units provided at positions across from the respective image carriers and configured to transfer the toner images carried by the image carriers to the intermediate transfer member; and
a second-transfer unit provided on a downstream side relative to the plurality of first-transfer units in the direction of rotation of the intermediate transfer member and configured to transfer the toner images on the intermediate transfer member to a medium.

2. An image forming apparatus comprising:
image forming units for four colors configured to form respective toner images in respective colors of yellow, magenta, cyan, and black that are to be combined into a color image;
a special-color image forming unit configured to form a toner image in a special color;
an endless-shaped intermediate transfer member that is rotatable in a peripheral direction of the intermediate transfer member and to which the toner images are to be sequentially transferred from the image forming units for the four colors and the special-color image forming unit;
a moment-of-inertia-increasing structure provided to one of rotatable image carriers that are included in the respective image forming units including the image forming units for the four respective colors and the special-color image forming unit, the moment-of-inertia-increasing structure increasing a moment of inertia of the one image carrier relative to moments of inertia of other ones of the image carriers, the one image carrier being included in one of the image forming units for the four respective colors that is located at a downstreammost position in a direction of rotation of the intermediate transfer member excluding the special-color image forming unit, the image carriers being in contact with the intermediate transfer member and configured to carry the respective toner images;
a plurality of first-transfer units provided at positions across from the respective image carriers and configured to transfer the toner images carried by the image carriers to the intermediate transfer member; and
a second-transfer unit provided on a downstream side relative to the plurality of first-transfer units in the direction of rotation of the intermediate transfer member and configured to transfer the toner images on the intermediate transfer member to a medium.

3. The image forming apparatus according to claim 1,
wherein the plurality of image forming units are image forming units for four colors configured to form respective toner images in respective colors of yellow, magenta, cyan, and black that are to be combined into a color image,
wherein the image forming apparatus further includes a special-color image forming unit configured to form a toner image in a special color, the special-color image forming unit being provided on a downstream side relative to the plurality of image forming units for the four colors but on an upstream side relative to the second-transfer unit in the direction of rotation of the intermediate transfer member, and
wherein the image carrier included in the image forming unit at the downstreammost position is the image carrier included in a downstreammost one of the image forming units provided for the four colors and excluding the special-color image forming unit.

4. The image forming apparatus according to claim 1,
wherein the image carriers have cylindrical shapes with outside diameters that are substantially equal to one another.

5. The image forming apparatus according to claim 2,
wherein the image carriers have cylindrical shapes with outside diameters that are substantially equal to one another.

6. The image forming apparatus according to claim 1,
wherein the moment-of-inertia-increasing structure is obtained as a weight provided inside a cylindrical member included in the image carrier of the image forming unit at the downstreammost position, the weight being provided in such a manner as to rotate together with the cylindrical member.

7. The image forming apparatus according to claim 2,
wherein the moment-of-inertia-increasing structure is obtained as a weight provided inside a cylindrical member included in the image carrier of the image forming unit at the downstreammost position, the weight being provided in such a manner as to rotate together with the cylindrical member.

8. The image forming apparatus according to claim 1,
wherein the moment-of-inertia-increasing structure is obtained by making a thickness of a cylindrical member included in the image carrier of the image forming unit at the downstreammost position greater than thicknesses of cylindrical members included in other ones of the image carriers.

9. The image forming apparatus according to claim 2,
wherein the moment-of-inertia-increasing structure is obtained by making a thickness of a cylindrical member included in the image carrier of the image forming unit at the downstreammost position greater than thicknesses of cylindrical members included in other ones of the image carriers.

10. The image forming apparatus according to claim 1,
wherein the moment-of-inertia-increasing structure is obtained as a weight provided coaxially with a cylindrical member included in the image carrier of the image forming unit at the downstreammost position, the weight being provided outside the cylindrical member in an axial direction and in such a manner as to rotate together with the cylindrical member.

11. The image forming apparatus according to claim 2,
wherein the moment-of-inertia-increasing structure is obtained as a weight provided coaxially with a cylindrical member included in the image carrier of the image forming unit at the downstreammost position, the weight being provided outside the cylindrical member in an axial direction and in such a manner as to rotate together with the cylindrical member.

12. The image forming apparatus according to claim 1,
wherein the first-transfer units include respective transfer rotating members that are in contact with an inner peripheral surface of the intermediate transfer member, and
wherein a load to be applied to a nip between the image carrier of the image forming unit at the downstreammost position and a corresponding one of the transfer rotating members is greater than a load to be applied to a nip between each of the image carriers of other ones of the image forming units and a corresponding one of the transfer rotating members.

13. The image forming apparatus according to claim 2,
wherein the first-transfer units include respective transfer rotating members that are in contact with an inner peripheral surface of the intermediate transfer member, and
wherein a load to be applied to a nip between the image carrier of the image forming unit at the downstreammost position and a corresponding one of the transfer rotating members is greater than a load to be applied to a nip between each of the image carriers of other ones of the image forming units and a corresponding one of the transfer rotating members.

14. The image forming apparatus according to claim 1,
wherein the first-transfer units include respective transfer rotating members that are in contact with an inner peripheral surface of the intermediate transfer member, and
wherein a transfer bias to be applied between the image carrier of the image forming unit at the downstreammost position and a corresponding one of the transfer rotating members is greater than a transfer bias to be applied between each of the image carriers of other ones of the image forming units and a corresponding one of the transfer rotating members.

15. The image forming apparatus according to claim 2,
wherein the first-transfer units include respective transfer rotating members that are in contact with an inner peripheral surface of the intermediate transfer member, and
wherein a transfer bias to be applied between the image carrier of the image forming unit at the downstreammost position and a corresponding one of the transfer rotating members is greater than a transfer bias to be applied between each of the image carriers of other ones of the image forming units and a corresponding one of the transfer rotating members.

16. The image forming apparatus according to claim 1, further comprising:
a driving unit configured to drive the intermediate transfer member and provided at a position between the second-transfer unit and one of the image carriers that is located at an upstreammost position in the direction of rotation of the intermediate transfer member.

17. The image forming apparatus according to claim 2, further comprising:
a driving unit configured to drive the intermediate transfer member and provided at a position between the second-transfer unit and one of the image carriers that is located at an upstreammost position in the direction of rotation of the intermediate transfer member.

18. An image forming apparatus comprising:
a plurality of image forming means for forming respective toner images in different colors;
an endless-shaped intermediate transfer member that is rotatable in a peripheral direction of the intermediate transfer member and to which the toner images are to be sequentially transferred from the plurality of image forming means;
a moment-of-inertia-increasing structure provided to one of rotatable image carriers that are included in the respective image forming means, the moment-of-inertia-increasing structure increasing a moment of inertia of the one image carrier relative to moments of inertia of other ones of the image carriers, the one image carrier being included in one of the image forming means that is located at a downstreammost position in a direction of rotation of the intermediate transfer member, the image carriers being in contact with the intermediate transfer member and configured to carry the respective toner images;
a plurality of first-transfer means for transferring the toner images carried by the image carriers to the intermediate transfer member, the plurality of first-transfer means being provided at positions across from the respective image carriers; and
second-transfer means for transferring the toner images on the intermediate transfer member to a medium, the second-transfer means being provided on a downstream side relative to the plurality of first-transfer means in the direction of rotation of the intermediate transfer member.
